(19) United States
(12) Patent Application Publication
(10) Pub. No.: US 2014/0110968 A1
(43) Pub. Date: Apr. 24, 2014

(54) AERODYNAMIC CONTROL SYSTEM FOR TRAILERS

(71) Applicant: Robert R. Henderson, Salem, OR (US)

(72) Inventor: Robert R. Henderson, Salem, OR (US)

(21) Appl. No.: 13/656,946

(22) Filed: Oct. 22, 2012

(51) Int. Cl. B62D 35/00

(52) U.S. Cl. CPC B62D 35/001
USPC 296/180.4

(57) ABSTRACT

An aerodynamic system that may have forward mounted airflow directional panels and an airfoil device mounted either in a firm or movable manner to the underneath side of a truck trailer just forward of the trailer tires and axles to better manage airflow around the trailer tire and axle assembly. In operation, the device collects and routs impinging air to exit between the trailer tires and well past the end of the trailer for controlled road spray and splash while keeping tires and brakes running cooler and decreasing parasitic drag of the trailer as it moves along the highway while reducing driver fatigue due to the improved handling characteristics.

### CROSS-REFERENCE TO RELATED APPLICATIONS

None

### FEDERALLY SPONSORED RESEARCH

None

### SEQUENCE LISTING

None

### BACKGROUND

This invention relates to heavy truck trailers, specifically providing a means to improve fuel mileage and to provide spray and splash control of trailer tire assemblies. It is well known that the vacuum formed at the back doors of the trailer reduces fuel mileage due to parasitical aerodynamic drag. It is also well known by highway travelers that trucks and trailers kick up voluminous amounts of splash and spray whenever the highways are wet that creates very hazardous driving conditions. This invention directs air onto an airfoil device that directs the air out behind the rear trailer doors between the trailer tires and it draws the air down to the highway surface thus improving fuel mileage and eliminating splash and spray.

Both U.S. Pat. No. 4,640,541 to FitzGerald, et al. (1987) and U.S. Pat. No. 4,262,953 to McErlane (1981) show under mounted air deflectors for truck trailers. These are deflector panels mounted ahead of the rearmost set of wheels that direct the air down and around the deflector. These units also direct the air around in a horizontal manner away from the centerline of the trailer and back parallel to the centerline of the trailer. This causes the air to impinge upon the rotating tires reducing fuel mileage and increasing spray and splash. These units also increase aerodynamic drag similarly to the flat faces of the trailer doors.

U.S. Pat. No. 4,486,046 to Whitney, et al. (1984) uses air stream deflectors on the underside of a semi-trailer that direct the air towards the centerline of the trailer tires. The water-entrained air causes aerodynamic drag and the rotating tires cause more spray and splash in a manner that is worse than without the unit.

The new system devices incorporate two vertical panels that direct air to an under mounted airfoil mounted ahead of the rearmost trailer tire assembly. The incoming air flows over both the top and under side of the airfoils that go all the way across from either outboard side of the trailer. The airfoils are shaped and positioned in a way to direct all of the impinging air to exit in a parallel manner to the pavement between the trailer tires out well past the rear of the trailer doors.

The two forward panels are connected to the underside of the trailer and placed on an angle alignment from the outer edge of the trailer towards the center of the airfoil as viewed from above. These outer panels direct voluminous amounts of air towards the rear mounted airfoil.

The airfoils are supported on both ends by vertical panels attached to the underneath side of the trailer in a solid manner or movable to allow the whole device to slide forward or back along the centerline of the trailer if the trailer axles are moved. The airfoil's side panels are cut to a predetermined angle and depth that allows collection of the air so that most of the air will be forced to exit between the trailer tires and over the axles without producing high aerodynamic drag as seen in FIG. 1 and FIG. 2. The between-tire exit air draws air past the tires keeping the tires and brakes cool while at the same time reducing spray and splash as indicated in FIG. 1 and FIG. 2.

The airfoils are separated by three ribs that are positioned in a manner that the two outboard ribs direct impinging air away from the trailer tires and towards the centerline of the trailer as shown in FIG. 4.

The panels are connected to each other in a contiguous manner using double-sided construction tape. Said tape is of a plastic medium that allows for the extreme vibrations found existing on the trailer during loading, unloading and traveling down the road without connection failures. A flexible adhesive could replace the tape.

### SUMMARY

The invention, an improved under mounted air management system, is comprised of two outboard panels that direct air towards an airfoil shape that manages as much air as possible to exit between the trailer tires. The large volume of managed air is forced to increase in velocity as it exits between the tires thus producing a low-pressure area below and behind the trailer doors that draws the outside air around the back edge formed by the corners of the trailer. The reduction of the parasitic aerodynamic drag caused by the doors thereby increases fuel mileage. Splash and spray is reduced as the surrounding air is drawn into the low-pressure area. The airfoil section is made to mount firmly or movable to the underside of a trailer.

Accordingly, several objects and advantages of the invention are to provide increased spray and splash control, to provide cooler running tires and brakes, to reduce aerodynamic drag that increases fuel mileage and it provides enhanced trailer handling that reduces driver fatigue. Still further objects and advantages will become apparent from a study of the following description and the accompanying drawings.

### DRAWINGS

FIG. 1. Is a side view of a semi-truck (T) and trailer (I) combination showing the airflow arrows 32, representing airflow as it forms traveling down the highway (R) at speed. The airfoil shapes of the device are visible as if the side panel was transparent. Note that the air flows over both sides of both airfoils. The invention component (II) is located just behind the truck (T) drive tires 11. The invention component (III) is located ahead of the trailer tire assembly 10 and 12.

FIG. 2. Is a cut-away view from above of invention component (III) of a semi-truck and trailer unit showing the airflow, as it forms due to the invention, traveling down the highway at speed. Air directional panels (II) are located just behind the truck's drive tires 11. Air—32—enters the second device (III) and leaves out the rear of the trailer.

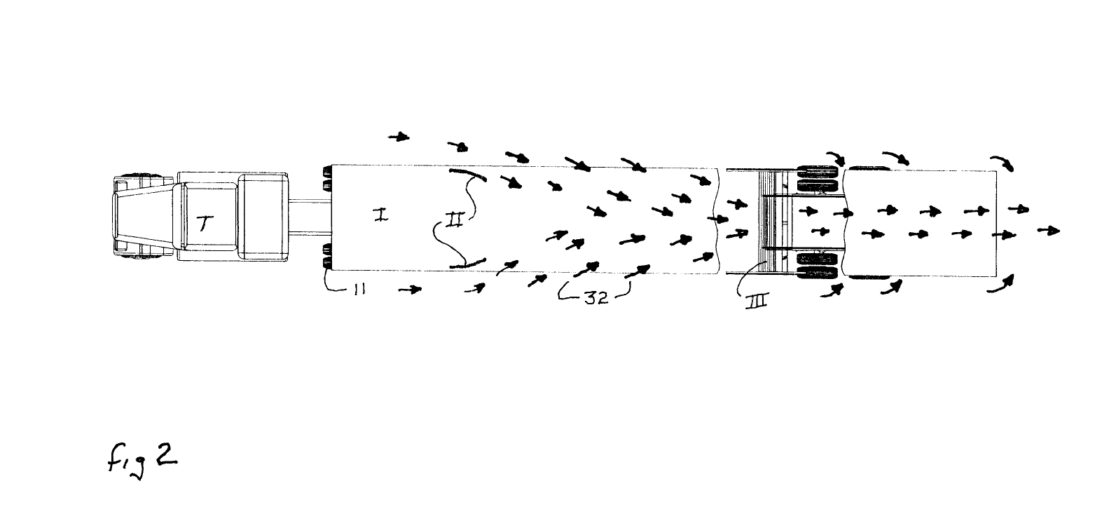

FIG. 3. Is a perspective view of the invention as viewed from above, ahead, and to the left of centerline.

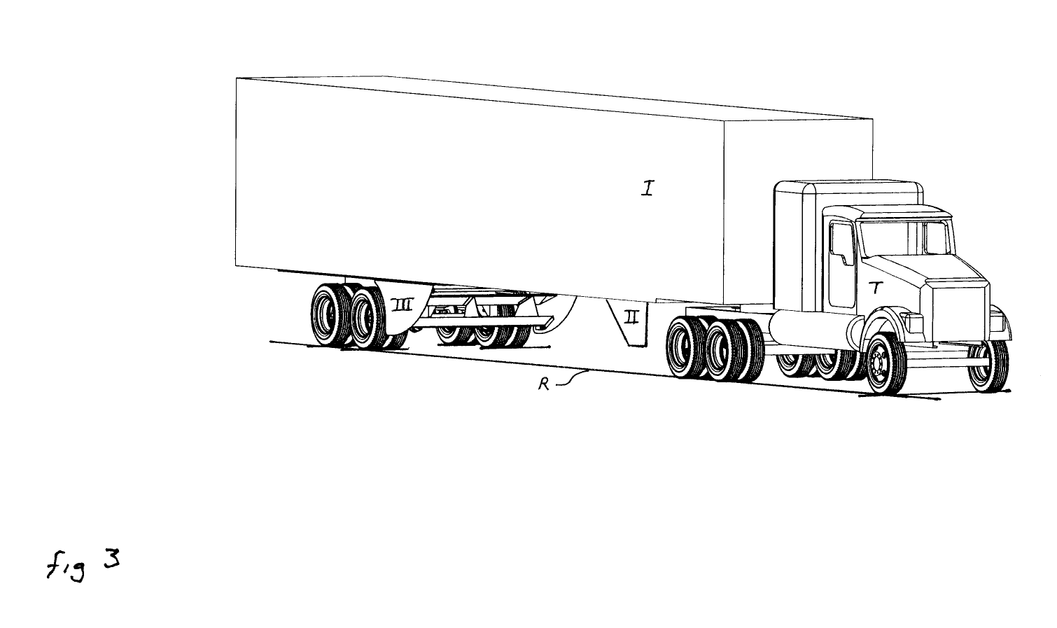

FIG. 4. Is a view of the invention component (III) as viewed from the front with the trailer box deleted for clarity. The top airfoil 19 and the lower airfoil 20 are separated by the ribs 1, 2, and 3. This view shows how ribs 1 and 3 are angled to direct the impinging air away from tires 10 and towards the centerline location parallel to rib 2.

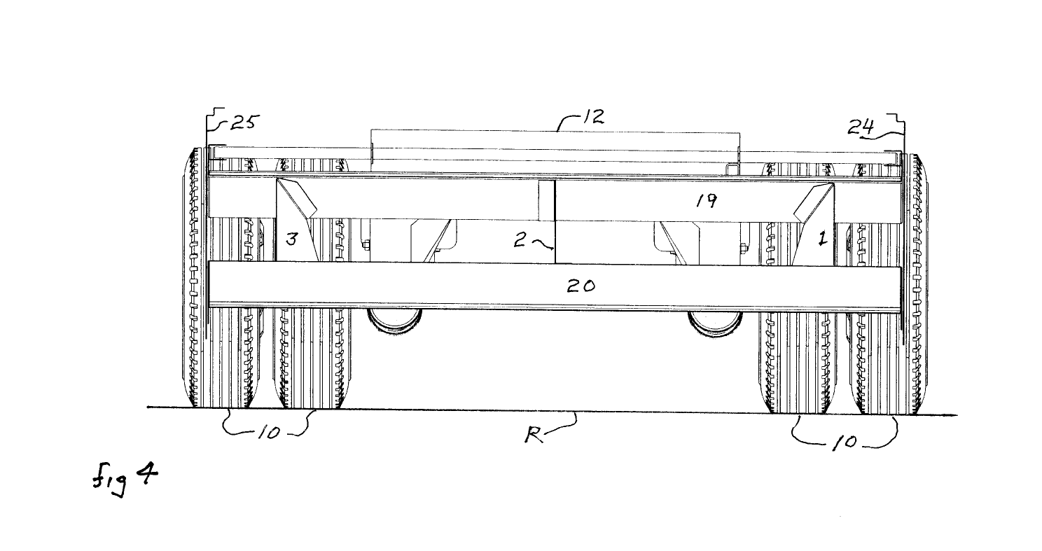

FIG. 5. Is a view of the invention component (III) as view from ahead and to the left with the trailer box deleted for clarity. The relationship of upper airfoil 19 and lower airfoil 20 to the vertical side panels 24 and 25 is clearly seen in this view. The relationship between upper airfoil 19 and lower airfoil 20 to ribs 1 and 2 are seen in this view.

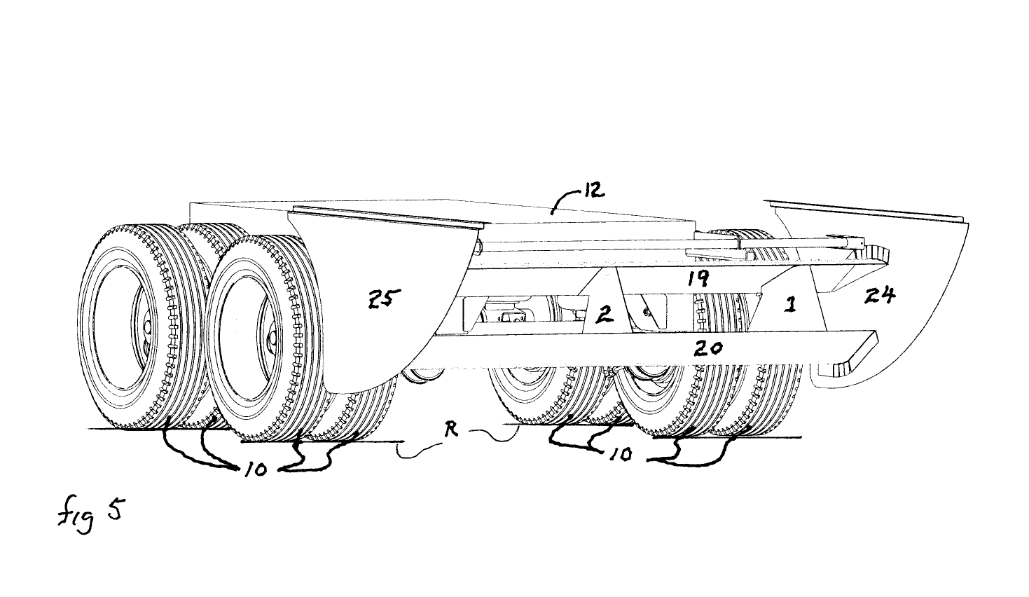

### DETAILED DESCRIPTION

### Reference Numerals

1 Driver's side Rib

2 Center Rib

3 Passenger side Rib

10 Trailer tires

11 Truck drive tires

12 Trailer axle frame

19 Airfoil upper

20 Airfoil lower

24 Driver's side vertical panel

25 Passenger side vertical panel

32 Air flow arrows

### OPERATION

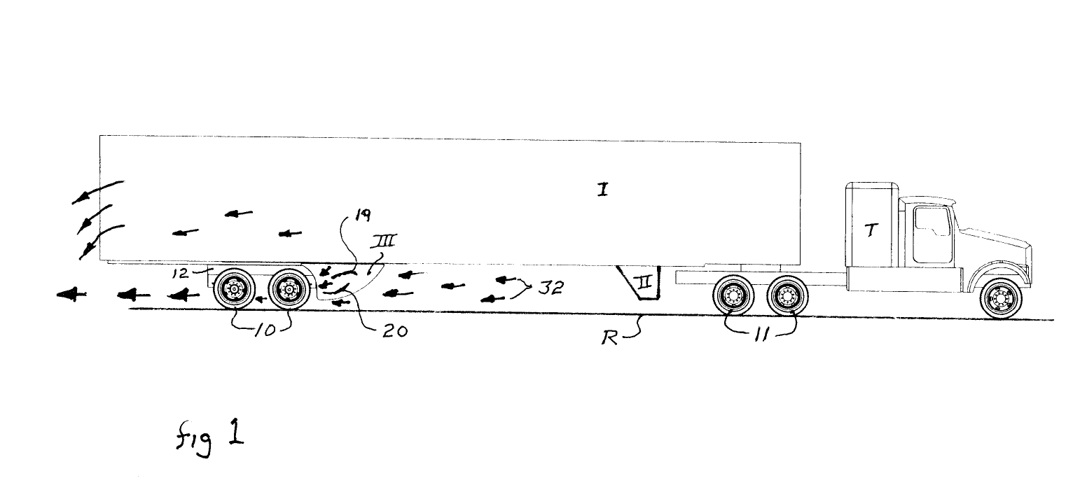

In operation, the device collects the air that impinges upon the airfoil panels 19 and 20 and is kept from exiting laterally by the vertical panels 24 and 25 and vertical Ribs 1, 2 and 3. The Ribs 1 and 3 are producing a venture effect from the impinging air. The extension of the vertical panels 24 and 25 beyond the two airfoils 19 and 20 are predetermined to avoid unnecessary aerodynamic drag. The easiest path for the air is to exit down towards the ground and back between the trailer tires 10 and underneath the trailer axles. The ensuing pressurized air must exit at a greater velocity, thus forming a negative pressure area between the tires that exits well past the end of the trailer. This low-pressure area now draws air from beyond the trailer tires towards the centerline of the vehicle bringing with it any rain or moisture from the roadway. The air is forced continually towards the rear of the trailer as the device and trailer continues forward down the road. The air now exits the rear of the trailer at a velocity that creates a low-pressure area low and behind the trailer. This air draws the surrounding air down around the vertical corners of the trailer as seen in FIG. 1 thus removing the normally existing low pressure area found at the back doors of the trailer while it keeps any road spray down low to the roadway again reducing spray and splash enhancing safety by increasing visibility for both the truck driver and other nearby motorists.

1. AERODYNAMIC CONTROL SYSTEM FOR TRAILERS (ACSFT) comprising two vertical panels mounted just behind the truck's drive tires and angled from the outside forward edge towards the centerline of the trailer that directs air onto a rear mounted airfoil device.

2. ACSFT per claim 1 whereby two vertical panels that sandwich 2 sloped airfoils.

3. ACSFT per claim 1 whereby the airfoil device will mount either in a firm or movable manner to the underneath side of a truck trailer just forward of the trailer tires and axles to better manage air flow between the trailer tires and around the axle assembly.

4. ACSFT per claim 1 whereby the panels are connected to each other in a contiguous manner using double-sided construction tape. A flexible adhesive could replace the tape.
